(19) United States
(12) Patent Application Publication
(10) Pub. No.: US 2011/0264889 A1
(43) Pub. Date: Oct. 27, 2011

(54) SYSTEMS AND METHODS FOR PROCESSING DATA

(75) Inventor: Christopher Stolarik, Sharon, MA (US)

(73) Assignee: MIRICS SEMICONDUCTOR LIMITED, Fleet Hampshire (GB)

(21) Appl. No.: 12/764,382

(22) Filed: Apr. 21, 2010

(51) Int. Cl. G06F 15/76; G06F 9/06

(52) U.S. Cl. 712/30; 712/E09.003

(57) ABSTRACT

Systems, methods, and an article of manufacture for the reduction in process load experienced by a primary processor when executing an application by dynamically reassigning portions of the application to one or more secondary processors are shown and described. A second processing unit is queried for one or more characteristics. One or more performance characteristics of the second processor are measured. A portion of the application can be reassigned to the second processing unit based on the queried characteristics and performance measurements.

### TECHNICAL FIELD

The present subject matter relates to techniques and equipment for processing data. More specifically, the subject matter relates to techniques and equipment for distributing processing among multiple processing units.

### BACKGROUND

Some applications require processor intensive operations. For example, a software-based demodulator function may require in excess of a million instruction per seconds (MIPs) to execute its various signal processing functions on a broadband TV signal. Such an application can consume a relatively high CPU load thus limiting the scope for other applications to run simultaneously in a multitasking environment. Similarly some older or less capable computing devices simply may not have the processing power available in the main central processing unit (CPU) to execute the software demodulation function quickly to enable real-time demodulation of the signal. In particular, the reception of European digital TV signals can require more processing time and U.S. digital TV signals.

### SUMMARY

In one example, the present disclosure is directed to one or more and various combinations of a system, method, and article of manufacture that reduce the processing load experienced by a central processing unit (CPU) during the execution of an application. By leveraging a second processing unit, the processing load can be distributed among the processors. Of course, more than two processors can be used. Also, dynamically determining the availability and capabilities of the second processing unit allows for reconfiguration of the distribution of the processing. For example, each time a decoding application (or some other application) is executed by a computing device the capabilities and availability of the second processing unit can be queried and used to determine the processing load distribution.

In one aspect, the disclosure is directed to a method of reducing the processing load experienced by a central processing unit (CPU) during the execution of an application. The method includes querying a second processing unit for one or more device characteristics, measuring one or more performance characteristics of the second processing unit, and determining a portion of the application to reassign to the second processing unit, based on the queried second processing unit device characteristics and the measured performance characteristics of the second processing unit. The CPU is in communication with the second processing unit.

In various examples, the portion of the application includes a Viterbi decoding algorithm. The application can include a digital television signal demodulation application. The one or more second processing unit device characteristics are selected from the group consisting of a number of processing cores, a vendor, and a processing speed of second processing unit.

In some examples, the one or more performance characteristics are selected from the group consisting of data transfer rate, execution time of Viterbi decoding algorithm over a known length of data. The second processing unit can include a graphics processing unit (GPU). Also, the querying the second processing unit occurs each time the application begins execution.

In another example, a computing system for processing data is described. The system includes a central processing unit (CPU) and second processing unit. The second processing unit has one or more device characteristics. The CPU is in the communication with the second processor. The CPU executes an application. The CPU queries the second processing unit for one or more of the second processing unit device characteristics, measures one or more performance characteristics of the second processing unit, and determines a portion of the application to reassign to the second processing unit, the percentage based on the queried second processing unit device characteristics and the measured memory transfer rate.

In one example, the disclosure features various form-factors that implement the processing distribution described herein. In one example, the CPU and second processor are located in a set-top box and associated software is executed by the CPU and second processing unit. In another example, the processor is located in cellular telephone and that the associated software is executed by the telephone. Of course, radios can include a processor that executes the associated software. Also, the CPU and second processing unit (e.g., a graphics processing unit) can be located in a computing device such as a desktop or portable (e.g., laptop, netbook, or tablet) computer. The associated software is executed by the computer.

Other concepts relate to unique software for distributing a processing load among a plurality of processing units. A software product, in accord with this concept, includes at least one machine readable medium and information carried by the medium. The information carried by the medium may be executable program code.

In another example, the disclosure relates to an article of manufacture. The article includes a machine readable storage medium and executable program instructions embodied in the machine readable storage medium that when executed by a programmable system causes the system to perform functions for reducing the processing load experienced by a central processing unit (CPU) during the execution of an application. The functions include querying a second processing unit for one or more second processing unit device characteristics, measuring one or more performance characteristics of the second processing unit, and determining a portion of the application to reassign to the second processing unit, the percentage based on the queried second processing unit device characteristics and the measured performance characteristics of the second processing unit.

In another example, a method of operating a data processing system performing one or more of the above-described operations is described. Also, the data processing system can include means for carrying the various described methods. The processing system can include one or means for carrying out the respective steps of the methods described. In addition, a computer program product is adapted to perform the various described methods. The computer program product can include software code that is adapted to perform the various described methods. Also, one or more feature of the disclosure can be embodied as data structures. In some instances, various aspects of the disclosure can be embodied in signals (e.g., carrier waves or the like).

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a functional block diagram of an embodiment of a system for performing serial concatenated decoding.

FIG. 2 is a flow chart depicting an embodiment of a method for performing serial concatenated decoding.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various examples disclosed herein relate systems, method, and articles of manufacture for performing serial concatenated decoding. The serial concatenated decoding described herein reduces, in some instances, the processing load experience by a processor when compared to other serial concatenated decoding systems. This reduction in load frees the processing resources to perform other tasks while decoding data.

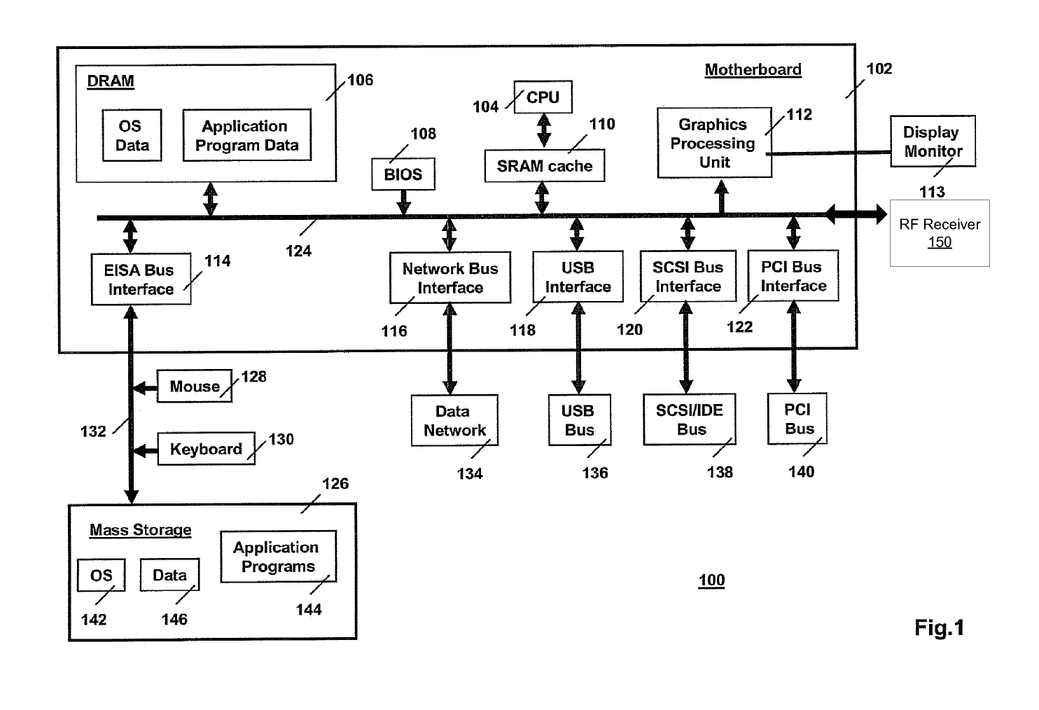

Reference now is made in detail to the examples illustrated in the accompanying drawings and discussed below. FIG. 1 is a block diagram of an exemplary data processing system, for example a typical personal computer (e.g., desk top, laptop, notebook, netbook, or tablet computer) (PC) 100. PC 100 comprises a motherboard 102 that accommodates a central processing unit (CPU) 104, main memory 106 (typically a volatile memory such as DRAM), a Basic Input/Output System (BIOS) 108 implemented in a non-volatile memory for booting PC 100, a fast SRAM cache 110 that is directly accessible to CPU 104, a graphics processing unit (GPU) 112, and a variety of bus interfaces 114, 116, 118, 120 and 122, all coupled through a local bus 124.

Graphics processing unit (GPU) 112 serves to offload the compute-intensive graphics processing from CPU 104, as a result of which CPU 104 has more resources available for primary tasks. The GPU may have one or more processing cores. Typically manufactures of the GPU include, but are not limited too, NVIDIA and ATI. The GPU 112 is connected to a display monitor 113.

Interfaces 114-122 serve to couple a variety of peripheral equipment to motherboard 102. Interface 114 couples a mass storage 126, e.g., a hard drive, a mouse 128 and a keyboard 130 to local bus 124 via an Extended Industry Standard Architecture (EISA) bus 132. Interface 116 serves to couple local bus 124 to a data network 134, e.g., a LAN or WAN. Interface 118 serves to couple local bus 124 to a USB bus 136 for data communication with, e.g., a memory stick (not shown). Interface 120 serves to couple local bus 24 to an SCSI/IDE bus 138 for data communication with, e.g., an additional hard drive (not shown), a scanner (not shown), or a CD-ROM drive (not shown). The acronym “SCSI” stands for “Small Computer System Interface” and refers to a standard to physically connect a computer to peripheral devices for data communication. The acronym “IDE” stands for “Integrated Drive Electronics” and refers to a standard interface for connecting storage devices to a computer. Interface 122 serves to connect local bus 124 to a (peripheral Component Interconnect (PCI) bus that serves to connect local bus 124 with peripherals in the form of an integrated circuit or an expansion card (e.g., sound cards, TV tuner cards, network cards). Mass storage 126 typically stores the operating system (OS) 142 of PC 100, application programs 144 and data 146 for use with OS 142 and application programs 144. When PC 100 is operating, main memory 106 stores the data and instructions for OS 142 and applications 144.

A RF receiver 150 also interfaces to the PC 100. The RF receiver is configured to receive analog and digital television and radio broadcasts in many regions of the world. For example, the RF receiver 150 receives broadcasts in PAL, NTSC, DVB-T, ATSC, DTMB, ISDB-T, DVB-H, T-DMB, CMMB, T-MMB, DRM, DAB, HD Radio, LW, MW, SW, and FM. In one example, the RF receiver is the FLEXIRF tuner developed by MIRICS Semiconductor of Fleet Hampshire in the United Kingdom.

The application program 144 can include a television signal processing application or radio signal processing application. Of course other applications can be distributed as described herein. In one example, the application program 144 in the MIRICS FLEXITV application. Such an application can process and decode multiple television formats. Exemplary formats include, but are not limited too, those used for digital television broadcasts in the United States, Europe, Japan, and Korea. In essence, the application enables nomadic reception of global analogue and digital broadcast standards on processor-based platforms such as notebook computers and next-generation computing devices. Demodulation of the received signal occurs in the host processor for maximum flexibility. For example, PC 100 performs processor-based demodulation algorithms. The SmartTuner performs multi-band RF tuning and ‘smart’ digital interfacing to the host-processor, as shown in the example. Using the CPU for demodulation, any analog or digital TV and radio standard can be received and demodulated, irrespective of whether the modulation scheme is based upon OFDM, VSB, AM, FM or other method.

During operation of the PC 100, the RF receiver 150 receives RF broadcasts and converts the broadcast to baseband for further processing by the PC 100. In one application, the PC 100 leverages the additional computational resources of the GPU 112. For example, certain portions of a demodulation 144 are designated to be completed by the GPU 112 instead of the CPU 104. In this way, the processing load of the CPU 104 is reduced. However, not every GPU 112 is created equal. Thus, a dynamic determination of which portions of the demodulation application 144 by the GPU 112 and CPU 104 is performed, in some embodiments, each time the demodulation application 144 is loaded and executed by the PC 100. Depending on the other tasks being performed by the GPU 112 when the demodulation application 144 is loaded by the PC 100, more or less of the demodulation application 144 can be executed by the GPU 112. For example, if a gaming application is leveraging the processing capabilities of the GPU 112 when the demodulation application 144 executes less of the demodulation application 144 may be assigned for execution to the GPU 112. Various other factors can also affect how much or little of the demodulation application 144 is performed on the GPU 112.

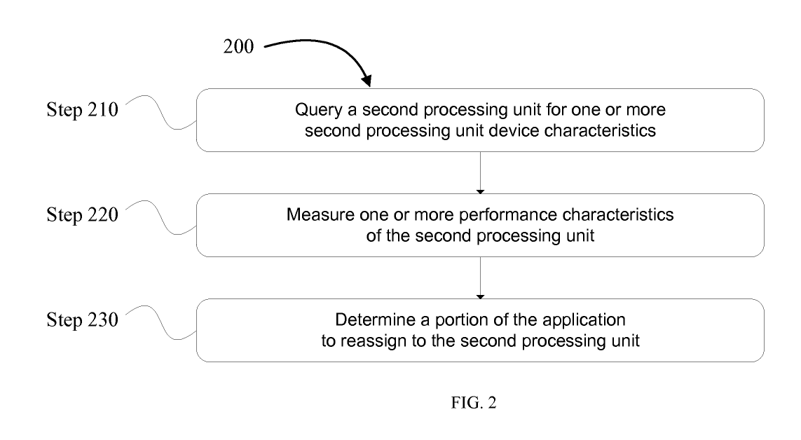

With reference to FIG. 2 a method 200 of reducing the processing load experienced by a central processing unit (CPU) during the execution of an application is shown and described. The method 200 includes querying (Step 210) a second processing unit (e.g., a graphics processing unit 112) that is in communication with the CPU 104 for one or more device characteristics of the second processing unit. For example, the CPU 104 can query the GPU 112 for one or more of the following: number of processing cores of the GPU 112; vendor of the GPU 112: and processor speed of second processing unit.

The method 200 also includes measuring (step 220) one or more performance characteristics of the second processing unit. Measuring 220 can include the CPU 104 sending the GPU 112 one ore more portions of the application program 144 to execute and timing the processing time needed to complete the task. For example, the CPU 104 can measure the execution time of Viterbi decoding algorithm over a known length of data as it executes in the GPU 112. In addition, measuring 220 can also include measuring the data transfer rate.

The method 200 further includes determining (step 230) a portion of the application program 144 (e.g., the Viterbi decoding algorithm) to reassign to the second processing unit. The determination 230 is based on the queried second processing unit device characteristics and the measured performance characteristics of the second processing unit (e.g., GPU 112). Thus, different GPUs 112 may receive more a less processing to perform based on the device characteristics and performance characteristics. For example, a GPU 112 with four cores may be reassigned a larger portion of the application than a GPU with only two cores. Also, the same GPU 112 may experience more a less processing load each time the application 144 executes. This is a result of the GPU 112 performing tasks for another application while the application 144 executes.

The following example provides additional detail related to the method 200 which determines a portion of the application program 144 that is reassigned to the second processing unit. Assume that the GPU 112 is an nVidia GPUs configured for use with the DVB-T digital television standard. The nVidia GPUs consist of one or more Streaming Multiprocessors (SMs). DVB-T transmits an MPEG-2 transport stream, which is made up of transport stream (TS) packets. One of the processes applied by the DVB-T transmitter to the TS data is a convolutional encoding, which can be decoded at the DVB-T receiver by Viterbi decoding.

The application program 144 executed by the PC 100 should Viterbi decode the TS packets. With the objective being to minimize the CPU 104 load, the application schedules the GPU 112 to process up to its compute capacity, and if any packets are remaining they will be sent to the CPU 104. For a given set of circumstances (GPU 112 capabilities, transmission parameters, etc.) the application treats the time to execute a unit of work by the GPU 112 as a fixed value. By monitoring the passage of time and keeping track of the number of work units sent to the GPU 112, the application can determine at any instant when the GPU 112 can complete processing the next unit of work it is given.

In DVB-T, data is transmitted in units of symbols, with the number of symbols per second being fixed for a given transmission. Depending on various transmission parameters, there will be some number of TS packets per symbol, again fixed for a given transmission. Assume that n=number of symbols.

Work is submitted to the GPU 112 using a kernel launch. Each kernel launch will process a number of TS packets and has execution time. The execution time is defined in symbol durations:

k_{g}=number of kernels submitted to GPU;

d=kernel execution time, in symbols;

t=gpu processing time available; and

t=n−k_{g}*d.

If t>0, there is processing time available on the GPU, and the kernel will be scheduled to run on the GPU. Otherwise, it is scheduled on the CPU.

Following these assumptions, an experimental determination of the maximum number of TS packets per second that could be Viterbi decoded by the GPU 112 without suffering any audio/video degradation is performed. This can be performed using a PC 100 with a GPU 112 of known configuration, thereby providing a baseline execution time.

Assume that Pgmax=Compute capacity of the GPU, in Packets/sec;

pk=packets per kernel launch;

r=symbols/sec; and

d, baseline=r*pk/Pgmax.

When the demodulation application is started, PC 100 interrogation (e.g., the GPU device characteristics and performance characteristics are determined and measured) is performed to determine the parameters that will influence the kernel duration. Scale factors are generated so that d, baseline can be adjusted to a value that is appropriate for the PC 100 in use.

The first set of weights are based on the transmission parameters of the received RF signal (e.g., the TV or radio broadcast). These characterize the differences in symbols/sec from the baseline PC system to the CP 100 in use. These first set of weights include:

w_bw=RF bandwidth weight=current RF bandwidth/8; and

w_gi=weight guard interval=1.25/(1+current guard interval). Guard interval is restricted to one of the following values by the DVB-T standard (0.25, 0.125, 0.0625, 0.03125).

The next set of weights reflect the characteristics of the GPU 112 itself. These include:

w_sm=Streaming multiprocessor weight=4/number SMs;

w_clk=GPU processor clock weight. If GPU clock<1.375 GHz, w_clk=1.375 GHz/GPU Clock, otherwise w_clk=1;

w_mem=Memory bandwidth weight. If measured bandwidth<12 Gbps, w_mem=12 Gbps/measured bandwidth, otherwise w_mem=1;

w_cal=Calibration weight. w_cal=measured calibration duration/calibration test duration on baseline; and

w_gpu=GPU weighting. w_gpu=max(w_cal, w_sw*w_clk*w_mem).

These weights and the baseline execution time are combined as follows: d=d, baseline*w_bw*w_gi*w_gpu.

As the demodulation application 144 executes, for every symbol the equation t=n−k_{g}*d is updated by incrementing n. Each symbol will have a fixed number of TS packets, and the packets will be placed in a buffer. When the buffer has more than pk packets, a kernel is formed and the equation t=n−k_{g}*d is evaluated. If t>0 then the kernel is scheduled to the GPU, and kg is incremented. If t<=0, the kernel is processed on the CPU and kg is left unchanged.

As described, aspects of the methods of reducing the processing load experienced by a CPU while executing a demodulation application outlined above may be embodied in programming. Program aspects of the technology may be thought of as “products” or “articles of manufacture” typically in the form of executable code and/or associated data that is carried on or embodied in a type of machine readable medium. “Storage” type media include any or all of the memory of the computers, processors or the like, or associated modules thereof, such as various semiconductor memories, tape drives, disk drives and the like, which may provide storage at any time for the software programming. All or portions of the software may at times be communicated through the Internet or various other telecommunication networks. Such communications, for example, may enable loading of the software from one computer or processor into another, for example, from a management server or host computer of the network operator or carrier into the computer platform of the data aggregator and/or the computer platform(s) that serve as the customer communication system. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the data aggregator, the customer communication system, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the above examples related to decoding in a television broadcasting environment the benefits described herein are equally applicable to radio broadcasts, cellular communications, and other communications systems where applications are executed. The technique described herein could be applied to any multiple processor system in order to distribute the processing load among the processors. Thus, a varying degrees of processor load reductions can be achieved.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method of reducing the processing load experienced by a central processing unit (CPU) during the execution of an application, comprising the steps of:
querying a second processing unit, in communication with the CPU, for one or more second processing unit device characteristics;
measuring one or more performance characteristics of the second processing unit; and
determining a portion of the application to reassign to the second processing unit, based on the queried second processing unit device characteristics and the measured performance characteristics of the second processing unit.

2. The method of claim 1 wherein the portion of the application comprises a Viterbi decoding algorithm.

3. The method of claim 1 wherein the application comprises a digital television signal demodulation application.

4. The method of claim 1 wherein measuring comprises sending one ore more portions of the application program to the second processor for executing execute and timing the processing time needed to complete the execution.

5. The method of claim 1 wherein the one or more second processing unit device characteristics are selected from the group consisting of a number of processing cores, a vendor, and a processing speed of second processing unit.

6. The method of claim 1 wherein the one or more performance characteristics are selected from the group consisting of data transfer rate and execution time of Viterbi decoding algorithm over a known length of data.

7. The method of claim 1 wherein the second processing unit comprises a graphics processing unit (GPU).

8. The method of claim 1 wherein querying the second processing unit occurs each time the application begins execution.

9. A computing system for processing data, the system comprising:
a second processing unit having one or more device characteristics; and
a central processing unit (CPU), in communication with the second processing unit, the CPU executing an application, querying the second processing unit for one or more of the second processing unit device characteristics, measuring one or more performance characteristics of the second processing unit, and determining a portion of the application to reassign to the second processing unit, the percentage based on the queried second processing unit device characteristics and the measured memory transfer rate.

10. The system of claim 9 wherein the portion of the application comprises a Viterbi decoding algorithm.

11. The system of claim 9 wherein the application comprises a digital television demodulation application.

12. The system of claim 9 wherein the one or more second processing unit device characteristics are selected from the group consisting of a number of processing cores, a vendor, and a processing speed of second processing unit.

13. The system of claim 9 wherein the one or more performance characteristics are selected from the group consisting of data transfer rate and execution time of Viterbi decoding algorithm over a known length of data.

14. The system of claim 9 wherein the second processing unit comprises a graphics processing unit (GPU).

15. The system of claim 9 wherein the CPU queries the second processing unit each time the application begins execution.

16. An article of manufacture comprising:
a machine readable storage medium; and
executable program instructions embodied in the machine readable storage medium that when executed by a programmable system causes the system to perform functions reducing the processing load experienced by a central processing unit (CPU) during the execution of an application, the functions comprising:
querying a second processing unit, in communication with the CPU, for one or more second processing unit device characteristics;
measuring one or more performance characteristics of the second processing unit; and
determining a portion of the application to reassign to the second processing unit, the percentage based on the queried second processing unit device characteristics and the measured performance characteristics of the second processing unit.

17. The article of manufacture of claim 16 wherein the first portion of the application comprises a Viterbi decoding algorithm.

18. The article of manufacture of claim 16 wherein the application comprises a digital television signal demodulation application.

19. The article of manufacture of claim 16, wherein measuring comprises sending one ore more portions of the application program to the second processor for executing execute and timing the processing time needed to complete the execution.

20. The article of manufacture of claim 16 wherein the one or more second processing unit device characteristics are selected from the group consisting of a number of processing cores, a vendor, and a processing speed of second processing unit.

21. The article of manufacture of claim 16 wherein the one or more performance characteristics are selected from the group consisting of data transfer rate and execution time of Viterbi decoding algorithm over a known length of data.

22. The article of manufacture of claim 16 wherein the second processing unit comprises a graphics processing unit (GPU).

23. The article of manufacture of claim 16 wherein querying the second processing unit occurs each time the application begins execution.

24. A method of reducing the processing load experienced by a first processing unit (CPU) during the execution of an application for processing broadcast signals, comprising the steps of:
querying a second processing unit, in communication with the first processing unit, for one or more second processing unit device characteristics;
measuring one or more performance characteristics of the second processing unit; and
determining a portion of the application for processing broadcast signals to reassign to the second processing unit, based on the queried second processing unit device characteristics and the measured performance characteristics of the second processing unit.
